(19) United States
(12) Patent Application Publication
(10) Pub. No.: US 2026/0218085 A1
(43) Pub. Date: Jul. 30, 2026

(54) FABRIC SOFTENERS WITH MAGNESIA

(71) Applicant: DEAD SEA BROMINE COMPANY LIMITED, Beer Sheva (IL)

(72) Inventors: Ella RAPAPORT, Lachish Darom (IL); Reut SRAELI, Meitar (IL); Mohammed ABUELHAIGA, Kibbutz Mefalsim (IL); Yelena Epstein ASSOR, Beer Sheva (IL); Orel AMAR, Ofakim (IL); Nikolay FUX, Beer Sheva (IL); Itzhak SHALEV, Bet Gamliei (IL); Alexander FRENKLACH, Lehavim (IL)

(21) Appl. No.: 19/147,140

(22) PCT Filed: May 13, 2024
(86) PCT No.: PCT/IL2024/050459

§ 371 Date: Jul. 10, 2025

Related U.S. Application Data
(60) Provisional application No. 63/503,494, filed on May 22, 2023.

(51) Int. Cl. C11D 3/00; C11D 1/62; C11D 3/12; C11D 3/22

(52) U.S. Cl. CPC C11D 3/001; C11D 1/62; C11D 3/1213; C11D 3/223; C11D 2111/12

(57) ABSTRACT

A composition including: (a) conventional fabric softener components; (b) magnesia (MgO); and (c) at least one member of the group consisting of cationic polyacrylo-nitrile and alkylamine ethoxylate. A related method of manufacture is also disclosed.

### CROSS REFERENCE TO RELATED APPLICATIONS

This PCT application claims the benefit according to 35 U.S.C. § 119(e) of U.S. provisional patent application 63/503,494 filed on 22/May/2023 and having the same title as the present application; which is fully incorporated herein by reference.

### FIELD OF THE INVENTION

The invention is in the field of fabric softeners.

### BACKGROUND OF THE INVENTION

Fabric softeners are often added to the laundry cycle in order to impart a soft and smooth feel to textiles. The softener acts as a lubricant, lowering the surface friction between the fibers and yarns themselves and between the fabric's surface and the skin. The softener also improves fabric drape and crease resistance. Softener formulations also often include perfumes for a pleasant aroma and hygroscopic agents to lower static electricity accumulation. Softener formulations are added after the main washing sequence, at the end of the laundry cycle.

Textile lubrication is typically achieved by adding long chain paraffin molecules. However, long chain paraffin molecules have little affinity to the textile fibers and would largely remain in the laundry water medium. Fortunately, most textile fiber acquire a negative surface charge in aqueous solutions (negative zeta potential). This phenomenon is utilized to obtain affinity by incorporating a cationic moiety on the long chain softener molecule. These cationic moieties include quaternary ammonium salts, amine salts, imidazolines and quaternaries with ester groups. The softener with cationic moieties then exhausts from the water solution onto the fiber surfaces, creating a lightly bound hydrophobic lubricating surface layer.

However, the hydrophobic surface layer on the fabric has the disadvantage of easily absorbing and accumulating oily soil, creating a dingy and gray appearance over time. For this reason, it is important that the softener-fiber ionic association is weak and easily dissociates in the next laundry cycle, removing the softener together with the adsorbed oily dirt. Therefore, a fresh application of softener is required at the end of every laundry cycle.

### SUMMARY OF THE INVENTION

One aspect of some embodiments of the invention relates to using a fabric softener as a vehicle and binder to hold magnesia (MgO) particles onto fiber surfaces. In some embodiments magnesia on the fiber surfaces contributes to positive skin sensation, and/or skin wellness, and/or odor mitigation, and/or skin pH balancing and/or perspiration absorption. Since the magnesia on the fiber surface is bound to the fabric softener, it is removed in every laundry cycle and re-applied with the next application of fabric softener.

Another aspect of some embodiments of the invention addition of cationic polyacrylo-nitrile and/or alkylamine ethoxylate to a fabric softener formulation contributes to an ability of magnesia to remain dispersed in the softener without phase separation or a dramatic increase in viscosity. In some exemplary embodiments of the invention, the cationic polyacrylo-nitrile is provided as a quaternary ammonium compound and/or as quaternary ammonium derivates. One example of a cationic polyacrylo-nitrile quaternary ammonium compound is SETAVIN LSP (Zschimmer & Schwarz, DE). One example of a cationic polyacrylo-nitrile quaternary ammonium derivate is SETAVIN ZAC (CAS: 68424-85-1; Zschimmer & Schwarz, DE). One example of an alkylamine ethoxylate is SETAVIN CDP (UFI ACN6-93H1-JC4K-SF8F; Zschimmer & Schwarz, DE).

A further aspect of some embodiments of the invention relates to a magnesia (MgO) pre-mix including MGO HA4 together with a liquid dispersant and a thickener in water. In some exemplary embodiments of the invention, the final; formulation is about 29% solids by weight. In some embodiments TERSPERSE® 2735 serves as the dispersant. TERSPERSE® 2735 is a styrene/methacrylic acid copolymer that is commercially available (Huntsman Corporation of The Woodlands, TX, USA). Alternatively or additionally, in some embodiments the thickener comprises Hydroxyethyl Cellulose such as, for example, CELLOSIZE™ QP-100MH Hydroxyethyl Cellulose (DOW Chemical).

According to various exemplary embodiments of the invention the final fabric softener formulation includes MgCl₂ and/or acetic acid.

It will be appreciated that the various aspects described above relate to solution of technical problems associated with product shelf life (prior to phase separation)

Alternatively or additionally, it will be appreciated that the various aspects described above relate to solution of technical problems related to product viscosity (the product must be easily poured into the fabric softener compartment of a washing machine).

Alternatively or additionally, it will be appreciated that the various aspects described above relate to transiently imparting additional characteristics to fabrics. According to various exemplary embodiments of the invention the additional characteristics include positive skin sensation, and/or skin wellness, and/or odor mitigation, and/or skin pH balancing and/or perspiration absorption.

In some exemplary embodiments of the invention there is provided a composition including: (a) conventional fabric softener components; (b) magnesia (MgO); and (c) at least one member of the group consisting of cationic polyacrylo-nitrile and alkylamine ethoxylate. In some embodiments the alkylamine ethoxylate includes SETAVIN CDP (UFI ACN6-93H1-JC4K-SF8F). Alternatively or additionally, in some embodiments the at least one cationic polyacrylo-nitrile comprises a quaternary ammonium derivate. Alternatively or additionally, in some embodiments the composition includes Hydroxyethyl Cellulose. Alternatively or additionally, in some embodiments the composition includes a dispersant.

In some exemplary embodiments of the invention there is provided a method of manufacture including: (a) preparing a pre-mix of magnesia (MgO) in water with a dispersant; and (b) adding a cationic polyacrylo-nitrile and an alkylamine ethoxylate and the pre-mix to a fabric softener to produce a magnesia enhanced fabric softener. In some embodiments the preparing includes: stirring liquid dispersant into water; and gradually adding magnesia powder with stirring; and then adding a thickener while stirring.

Some exemplary embodiments of the invention relate to Magnesia (MgO) for use as a fabric treatment in conjunction with fabric softener.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) are W/W (weight per weight) unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the FIGURES, identical and similar structures, elements or parts thereof that appear in more than one FIGURE are generally labeled with the same or similar references in the FIGURES in which they appear. Dimensions of components and features shown in the figures are chosen primarily for convenience and clarity of presentation and are not necessarily to scale. The attached FIGURES are:

FIG. 1 is a simplified flow diagram of a manufacturing method according to some exemplary embodiments of the invention.

### DETAILED DESCRIPTION OF EMBODIMENTS

Embodiments of the invention relate to compositions and manufacturing methods. Specifically, some embodiments of the invention can be used to transiently bond magnesia (MgO) to fabric using fabric softener as a vehicle. For purposes of this specification and the accompanying claims, the term “transiently bond” indicates that the magnesia remains on the fabric from the end of one laundry cycle until a subsequent laundry cycle. If the magnesia is not re-applied, the subsequent laundry cycle will remove it from the fabric.

The principles and operation of a composition and/or method according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Composition

In some exemplary embodiments of the invention there is provided a composition including, conventional fabric softener components, magnesia (MgO), and a cationic polyacrylo-nitrile and/or alkylamine ethoxylate. In some embodiments the alkylamine ethoxylate includes SETAVIN CDP (UFI ACN6-93H1-JC4K-SF8F). Alternatively or additionally, in some embodiments the at least one cationic polyacrylo-nitrile includes a quaternary ammonium derivate, such as, for example, SETAVIN ZAC (CAS: 68424-85-1). Alternatively or additionally, in some embodiments the composition includes Hydroxyethyl Cellulose. One example of Hydroxyethyl Cellulose suitable for use in the context of the composition is CELLOSIZE™ QP-100MH Hydroxyethyl Cellulose (DOW Chemical). Alternatively or additionally, in some embodiments the composition includes a dispersant. One example of a dispersant suitable for use in the context of the composition is a styrene/methacrylic acid copolymer such as TERSPERSE® 2735 (Huntsman Corporation of The Woodlands, TX, USA).

### Exemplary Method of Manufacture

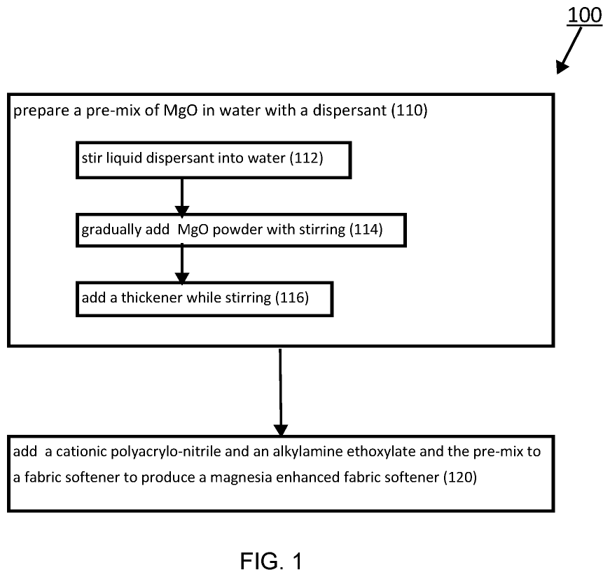

FIG. 1 is a simplified flow diagram of a manufacturing method, indicated generally as 100, according to some exemplary embodiments of the invention. Depicted exemplary method 100 includes preparing 110 a pre-mix of magnesia (MgO) in water with a dispersant and adding 120 a cationic polyacrylo-nitrile and an alkylamine ethoxylate and the pre-mix to a fabric softener to produce a magnesia enhanced fabric softener. In some exemplary embodiments of the invention, preparing 110 includes: stirring 112 liquid dispersant into water; gradually adding 114 magnesia powder with stirring; and then adding 116 a thickener while stirring.

It is expected that during the life of this patent many cationic polyacrylo-nitriles and alkylamine ethoxylates will be developed and the scope of the invention is intended to include all such new technologies a priori.

### Exemplary Benefits

In some exemplary embodiments of the invention, Magnesia (MgO) is provided for use as a fabric treatment in conjunction with fabric softener. Fabric treatment with MgO utilizes the fabric softener as a vehicle and binder to hold magnesia particles onto fiber surfaces. In some embodiments magnesia particles on fiber surfaces contribute to positive skin sensation and/or skin wellness and/or odor mitigation and/or skin pH balancing and/or perspiration absorption.

As used herein the term “about” refers to ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of magnesia but might also be used to disperse other alkaline earth metal oxides in fabric softener to transiently bind them to fabric fibers.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, which illustrate the invention in a non-limiting fashion.

### Materials and Methods

The following materials and methods are used in performance of experiments described in examples hereinbelow:

| MATERIAL | MANUFACTURER | FUNCTION |
|---|---|---|
| MgO-HA4 | ICL | Active ingredient |
| MgCl2 | ICL | Additive |
| Triton X - 100 | DOW | Liquid dispersant |
| Setavin ZAC | Zschimmer &Schwarz | Liquid dispersant |
| Setavin CDP | Zschimmer &Schwarz | Liquid dispersant |
| TERSPERSE 2735/2700 | Huntsman | Liquid dispersant |
| Cellosize TM, QP-100 | DOW | Thickener |
| HEC QP 100 MH, | | |

### Example 1

### Preparation of Magnesia (MgO) Pre-Mix

In order to facilitate dispersion of magnesia in fabric softener an aqueous pre-mix solution was prepared according to the formulation in table 1.

TABLE 1
MgO pre-mix: 29% solids

| Component | Amount [%] |
|---|---|
| Water | 69.1 |
| Liquid dispersant for water | 2.9 |
| dispersible granules, | |
| TERSPERSE 2735, Huntsman | |
| MgO HA4 | 27.6 |
| Thickener- CELLOSIZE ™, | 0.3 |
| QP-100 HEC QP 100 MH, Dow | |

Briefly, liquid dispersant (TERSPERSE 2735) was added to a measured amount of water and stirred. Next, MgO powder was gradually added while stirring was continued for 30 minutes. Finally, a thickener (HEC QP-100MH) was added.

This pre-mix was used in subsequent examples.

### Example 2

### Direct Addition of Pre-Mix to Fabric Softener

In order to determine whether the pre-mix alone is a suitable vehicle for dispersing magnesia in fabric softener, 19.3 grams of Pre-mix were added to 80.6 grams of a conventional fabric softener. The resultant mixture was unstable and phase separation occurred after a few hours. The lower phase was a stiff cake, and the upper phase was a liquid. The phase separation was apparently irreversible was not resolved by simple stirring.

This result suggested that additional ingredients are required in the formulation.

### Example 3

### Addition of Pre-Mix to Fabric Softener in the Presence of an Anionic Detergent

In order to test whether an anionic detergent could prevent phase separation, an additional experiment was conducted using TRITON X-100 (2.8%), magnesia premix (2.8%) and fabric softener (94.3%).

This formulation eliminated phase separation but produced a highly viscous composition with low pourability. This result suggested that an anionic detergent is not the solution.

### Example 4

### Addition of Pre-Mix to Fabric Softener in the Presence of MgCl₂

In order to test whether an MgCl₂ could prevent phase separation while preserving pourability, an additional experiment was conducted using MgCl₂ (2.3%), magnesia premix (2.8%) and fabric softener (95%).

This formulation was unstable, with phase separation occurring after a few hours. This result suggested that additional divalent cations are not the solution.

### Example 5

Coating of Magnesia with Stearic Acid

In order to test whether coating of magnesia with stearic acid could prevent phase separation while preserving pourability, an additional experiment was conducted without use of the pre-mix of Example 1 as detailed in Table 2.

TABLE 2
MgO coated with 3% stearic acid formulation

| Component | Amount [%] |
|---|---|
| Water | 69 |
| Liquid dispersant for water | 2.9 |
| dispersible granules, | |
| TERSPERSE 2735, Huntsman | |
| MgO HA4 coated with | 27.7 |
| 3% stearic acid | |
| Thickener- CELLOSIZE ™, | 0.3 |
| QP-100 HEC QP 100 MH, Dow | |

This formulation was unstable, with phase separation occurring rapidly. This result suggested that the coated MgO was too hydrophobic.

### Example 6

### Addition of Pre-Mix to Fabric Softener in the Presence of an Setavin ZAC

In order to test whether SETAVIN ZAC could prevent phase separation, an additional experiment was conducted using SETAVIN ZAC (2.8%), magnesia premix (2.8%) and fabric softener (94.3%).

This formulation appeared acceptable on the day of preparation but, phase separation occurred after 1 week. This result suggested that SETAVIN ZAC is not the solution.

### Example 7

### Addition of Pre-Mix to Fabric Softener in the Presence of an Setavin ZAC

In order to test whether SETAVIN ZAC could prevent phase separation, an additional experiment was conducted using SETAVIN ZAC (2.8%), magnesia premix (2.8%) and fabric softener (94.3%).

This formulation appeared acceptable on the day of preparation, but phase separation occurred after 1 week. This result suggested that SETAVIN ZAC is not the solution.

An experiment on 45/55 polyethylene cotton fabric was conducted using regular fabric softener as a control to determine if the magnesia enhanced fabric softener imparted anti-bacterial (Staphylococcus aureus—ATCC 6538) properties to the laundered fabric. There was no difference between fabric treated with regular fabric softener and magnesia enhanced fabric softener (data not shown).

### Example 8

### Addition of Pre-Mix to Fabric Softener in the Presence of an Setavin CDP

In order to test whether SETAVIN CDP could prevent phase separation, an additional experiment was conducted using SETAVIN CDP (5.5%), magnesia premix (2.7%) and fabric softener (91.7%).

This formulation was too viscous for pouring. This result suggested that SETAVIN CDP is not the solution.

An experiment on 45/55 polyethylene cotton fabric was conducted using regular fabric softener as a control to determine if the magnesia enhanced fabric softener imparted anti-bacterial (Staphylococcus aureus—ATCC 6538) properties to the laundered fabric. There was no difference between fabric treated with regular fabric softener and magnesia enhanced fabric softener (data not shown).

### Example 9

### Addition of Pre-Mix to Fabric Softener in the Presence of Setavin ZAC and Setavin CDP

In order to test whether SETAVIN ZAC and SETAVIN CDP could prevent phase separation, an additional experiment was conducted using SETAVIN CDP (2.7%), SETAVIN ZAC (2.7%), magnesia premix (2.7%) and fabric softener (91.9%)

This formulation was both stable without phase separation and pourable. This result suggested that SETAVIN CDP in combination with SETAVIN ZAC is a viable formulation option for delivering magnesia to fabric using fabric softener as a vehicle.

An experiment on 45/55 polyethylene cotton fabric was conducted using regular fabric softener as a control to determine if the magnesia enhanced fabric softener imparted anti-bacterial (Staphylococcus aureus—ATCC 6538) properties to the laundered fabric. There was no difference between fabric treated with regular fabric softener and magnesia enhanced fabric softener (data not shown).

### Example 10

### Influence of Varying Amounts of Pre-Mix Setavin ZAC and Setavin CDP on Anti-Bacterial Activity

In order to test whether magnesia delivered to fabric via fabric softener would impart anti-bacterial properties to the fabric, an additional series of experiments with varying amounts of SETAVIN ZAC, SETAVIN CDP and magnesia pre-mix was conducted.

All of the formulations based on SETAVIN ZAC, SETAVIN CDP and magnesia pre-mix had good stability and good pourability.

For each formulation, antibacterial assays were conducted on fabric using regular fabric softener as a control to determine if the magnesia enhanced fabric softener imparted anti-bacterial (Staphylococcus aureus—ATCC 6538) properties to the laundered fabric.

In the first experiment a formulation as in table 3 was used and effect on bacteria is summarized in table 4.

TABLE 3
3.8% MgO

| Component | Amount [gr] | % |
|---|---|---|
| Softener | 58.1 | 58.1 |
| Setavin CDP | 13.9 | 13.9 |
| Setavin ZAC | 13.9 | 13.9 |
| MgO Pre-Mix | 13.9 | % MgO 4% |
| (29% solids) | | Water and |
| | | surfactant |
| | | 9.9% |

TABLE 4
Results obtained with Staphylococcus aureus - cotton fabric- ATCC 6538

| | | % MgO | Bacterial count (after different | | | |
|---|---|---|---|---|---|---|
| | | On | contact times) CFU/ml | | | |
| Fabric | Treatment | fabric | 0 | 2 hr | 5 hr | 24 hr |
| 100% | Untreated | 0 | 3.40 × 10⁵ | 6.30 × 10⁵ | 1.00 × 10⁸ | 3.70 × 10⁹ |
| Cotton | blank | | | | | |
| | fabric | | | | | |
| 100% | Treated | 0.36 | — | 2.20 × 10³ | 1.80 × 10⁵ | 1.50 × 10⁶ |
| Cotton | fabric | | | | | |

Results summarized in table 4 indicate that bacteria started to grow on the untreated fabric sample after 5 hours. An increase of 3 and 4 orders of magnitude was observed after 5 and 24 hours, respectively.

Relative to the untreated “blank”, decrease of 2 logs was seen on the MgO treated sample after a contact time of 2 hours. After 24 hours the same sample showed an increase of 1 log, but was still 3 logs below the “blank”.

Although some bacterial growth was observed on the treated fabric, bacterial numbers were at least two or three orders of magnitude less than untreated at every time point. This result demonstrates a significant anti-bacterial effect using 0.36% MgO.

In the next experiment a formulation as in table 5 was used and effect on bacteria is summarized in table 6.

TABLE 5
7.1% MgO

| Component | Amount [gr] | % |
|---|---|---|
| Softener | 51 | 51% |
| Setavin CDP | 12.2 | 12.2% |
| Setavin ZAC | 12.2 | 12.2% |
| MgO Pre-Mix | 24.5 | 7.1% MgO |
| (29% solids) | | 17.5 water |
| | | and |
| | | surfactant |

TABLE 6
Results obtained with Staphylococcus aureus - cotton fabric- ATCC 6538

| | | % MgO | Bacterial count (after different | | | |
|---|---|---|---|---|---|---|
| | | on | contact times) CFU/ml | | | |
| Fabric | Treatment | fabric | 0 | 2 hr | 5 hr | 24 hr |
| 100% | Untreated | 0 | 3.40 × 10⁵ | 6.30 × 10⁵ | 1.00 × 10⁸ | 3.70 × 10⁹ |
| Cotton | blank | | | | | |
| | fabric | | | | | |
| 100% | Treated | 0.66 | — | 2.00 × 10² | 2.30 × 10⁵ | 3.50 × 10⁶ |
| Cotton | fabric | | | | | |

Again, although some bacterial growth was observed on the treated fabric, bacterial numbers were at least two or three orders of magnitude less than untreated at every time point. This result demonstrates a significant anti-bacterial effect using 0.66% MgO. However, it is unclear whether the increased MgO concentration had a supplementary antibacterial effect.

In the next experiment a formulation as in table 7 was used and effect on bacteria is summarized in table 8.

TABLE 7
7.1% MgO

| Component | Amount [g] | % |
|---|---|---|
| Softener | 51 | 51% |
| Setavin CDP | 12.2 | 12.2% |
| Setavin ZAC | 12.2 | 12.2% |
| MgO Pre-mix | 24.5 | 7.1% MgO |
| (29% solids) | | 17.5 water |
| | | and |
| | | surfactant |

In table 8, the first three fabrics are untreated blanks. The first was not laundered at all. The second was laundered only washing powder. The third with was laundered with washing powder and fabric softener. No magnesia was used in these control treatments.

TABLE 8
Results obtained with Staphylococcus aureus - cotton fabric- ATCC 6538

| | | | Bacterial count (after different | | | |
|---|---|---|---|---|---|---|
| | | % MgO on | contact times) CFU/ml | | | |
| Fabric | Treatment | the fabric | 0 | 2 hr | 5 hr | 24 hr |
| 100% | Untreated | 0 | 3.50 × 10⁵ | 8.60 × 10⁵ | 4.10 × 10⁷ | 54.30 × 10⁹ |
| Cotton | blank | | | | | |
| | fabric | | | | | |
| 100% | Washed with | 0 | 2.20 × 10⁵ | 3.40 × 10⁵ | 1.10 × 10⁷ | 1.20 × 10⁹ |
| Cotton | washing | | | | | |
| | powder | | | | | |
| 100% | Washed with | 0 | 5.90 × 10⁵ | 3.80 × 10⁵ | 4.60 × 10⁶ | 2.90 × 10⁹ |
| Cotton | washing | | | | | |
| | powder + | | | | | |
| | softener | | | | | |
| 100% | First | 0.41 | — | 3.0 × 10² | 1.0 × 10² | 2.8 × 10² |
| Cotton | repetition | | | | | |
| 100% | Second | 0.4 | — | 1.5 × 10² | 1.3 × 10² | 2.5 × 10² |
| Cotton | repetition | | | | | |
| 100% | Third | 0.36 | — | 1.5 × 10² | 2.5 × 10² | 7.5 × 10¹ |
| Cotton | repetition | | | | | |

The bacteria started to grow on the 0% MgO control samples after 5 hours. An increase of 2 and 4 orders of magnitude was observed after 5 and 24 hours, respectively. There was no difference between the results of the 3 different control samples tested.

All the treated samples showed a decrease of 2 logs after a contact time of 2 hours.

The first repetition sample showed a decrease of 2 logs after a contact time of 5 hours, whereas samples second and third repetition samples showed a decrease of 1 log after the same contact time.

After a contact time of 24 hours all MgO treated samples showed significantly less bacterial growth than control samples that were not exposed to MgO.

Based on these experiments, it appears that a level of <0.33% MgO on the fabric is sufficient to obtain an antibacterial/biostatic effect compared to the controls.

Results summarized in Table 9 indicate that there is some residual MgO (and perhaps some softener) carried over from the previous laundry.

TABLE 9
Results obtained with Staphylococcus aureus - cotton fabric- ATCC 6538

| | | | Bacterial count (after different | | | |
|---|---|---|---|---|---|---|
| | | | contact times) CFU/ml | | | |
| [symbol] | Treatment | % MgO | 0 | 2 hr | 5 hr | 24 hr |
| 100% | Untreated | 0 | 2.9 × 10⁵ | 2.1 × 10⁵ | 2.9 × 10⁷ | 23.1 × 10⁹ |
| Cotton | blank | | | | | |
| | fabric | | | | | |
| 100% | Treated fabric- | 0.33 | — | 2.9 × 10³ | 1.7 × 10⁴ | 2.3 × 10⁵ |
| Cotton | laundry 1/4 | | | | | |
| 100% | Treated fabric | 0.5 | — | 3.5 × 10³ | 2.8 × 10² | 2.3 × 10⁴ |
| Cotton | laundry 2/4 | | | | | |
| 100% | Treated fabric | 0.66 | — | 9.3 × 10² | 63.5 × 103 | 1.3 × 10⁵ |
| Cotton | laundry 3/4 | | | | | |
| 100% | Treated fabric | 0.83 | — | 1.5 × 10² | 3.3 × 10³ | 1.0 × 10² |
| Cotton | laundry 4/4 | | | | | |

All the treated samples showed a decrease of 2-3 logs after a contact time of 2 hours relative to untreated blank fabric.

The sample assayed after 1 laundry showed a decrease of 1 log after 5 hours, whereas samples assayed after 2, 3 and 4 laundries showed a decrease of 2 logs after the same contact time.

Some deviations between the duplicate results were observed in some of the samples after 24 hours. The deviations are largely attributed to the inherent non-uniformity of softener deposition in the laundry machine. Still, most of the results indicate a biostatic effect comparing to zero time.

The overall conclusion is that the MgO is indeed deposited on the fabric with the fabric softener and remains there after the final rinse at the levels indicated in the tables above. The levels of deposited MgO are apparently sufficient to produce an antibacterial/biostatic effect as measured by standard tests.

The results indicate that the total amount of magnesia detected on the fabrics after each laundry cycle increases to some extent in the first laundries and then plateaus after about laundries (data not shown). It is believed that there are at least two contributory factors to the observed increase in magnesia levels:
First, some residual magnesia persists from cycle to cycle; and
Second, the fabric becomes more and more absorbent from cycle to cycle and takes up a little more material. (This is a common textile effect).

Neither of these has factors has any impact on fabric performance since the fabric already performs well after the first laundry with magnesia added to the fabric softener. Despite the increase in concentration during the first laundry cycles, the preponderance of the magnesia is washed off in each laundry cycle.

### Example 11

### Confirmation in Cotton/Polyethylene Blended Fabrics

In order to test whether magnesia delivered to fabric via fabric softener would impart similar anti-bacterial properties to a cotton/synthetic blended fabric, an additional series of experiments 50% cotton/50% polyethylene was conducted using 10.8% MgO as detailed in Table 10.

All of the formulations based on SETAVIN ZAC, SETAVIN CDP and magnesia pre-mix had good stability and good pourability.

Antibacterial assays were conducted on fabric using regular fabric softener as a control to determine if the magnesia enhanced fabric softener imparted anti-bacterial (Staphylococcus aureus—ATCC 6538) properties to the laundered fabric. Results are summarized in Table 11.

TABLE 10
10.8% MgO formulation

| Component | Amount [%] |
|---|---|
| Softener | 41 |
| Setavin CDP | 9.8 |
| Setavin ZAC | 9.8 |
| MgO Pre-Mix | 39.2 |
| (29% solids) | |
| HEC | 0.2 |

TABLE 11
Results obtained with Staphylococcus aureus- ATCC 6538
- 50/50 Cot/PET treated with MgO formulation of table 10

| | | | Bacterial count (after different | | | |
|---|---|---|---|---|---|---|
| | | | contact times) CFU/ml | | | |
| Fabric | Treatment | % MgO | 0 | 2 hr | 5 hr | 24 hr |
| 50/50 | Untreated | 0 | 3.1 × 10⁵ | 4.6 × 10⁵ | 9.7 × 10⁷ | 3.7 × 10⁹ |
| Cot/PET | fabric | | | | | |
| 50/50 | Treated fabric | 0.83 | — | 3.0 × 10² | 1.5 × 10² | 5.4 × 10⁵ |
| Cot/PET | laundry 1/4 | | | | | |
| 50/50 | Treated fabric | 1.53 | — | <10² | 1.3 × 10² | 4.1 × 10⁴ |
| Cot/PET | laundry 2/4 | | | | | |
| 50/50 | Treated fabric | 1.91 | — | <10² | 6.0 × 10² | 7.1 × 10³ |
| Cot/PET | laundry 3/4 | | | | | |
| 50/50 | Treated fabric | 2.24 | — | 1.3E+02 | <100 | 1.6E+05 |
| Cot/PET | laundry 4/4 | | | | | |

50/50 Cot/PET fabric samples that were washed with the formulation of table 10 after 1, 2, 3 and 4 laundries, showed a decrease of 3-4 logs after a contact time of 2 and 5 hours.

TABLE 12
Results obtained with Staphylococcus aureus-
ATCC 6538 - 50/50 PET/Cot treated without MgO

| | | | Bacterial count (after different | | | |
|---|---|---|---|---|---|---|
| | | | contact times) CFU/ml | | | |
| Fabric | Treatment | % MgO | 0 | 2 hr | 5 hr | 24 hr |
| 50/50 | Untreated | 0 | 3.2 × 10⁵ | 4.2 × 10⁵ | 4.4 × 10⁷ | 6.7 × 10⁹ |
| PET/Cot | fabric | | | | | |
| 50/50 | Washed | 0 | 3.3 × 10⁵ | 5.2 | 7.9 × 10⁷ | 6.5 × 10⁹ |
| PET/Cot | with | | | | | |
| | washing | | | | | |
| | powder + | | | | | |
| | Setavin | | | | | |
| | ZAC + | | | | | |
| | Setavin | | | | | |
| | CDP + | | | | | |
| | softener | | | | | |

Results summarized in table 12 show that washing powder+Setavin ZAC+Setavin CDP+softener had no antibacterial activity. This establishes that the antibacterial activity observed in previous experiments is due to MgO.

TABLE 13
Results obtained with Staphylococcus aureus
- Untreated 100% Cotton fabric- ATCC 6538

| | | | Bacterial count (after different | | | |
|---|---|---|---|---|---|---|
| | | | contact times) CFU/ml | | | |
| Fabric | Treatment | % MgO | 0 | 2 hr | 5 hr | 24 hr |
| 100% | Washed | 0 | 3.0 × 10⁵ | 6.0 × 10⁵ | 6.1 × 10⁷ | 1.0 × 10¹⁰ |
| Cotton | with | | | | | |
| | washing | | | | | |
| | powder | | | | | |
| 100% | Untreated | 0 | 3.1 × 10⁵ | 6.0 × 10⁵ | 6.6 × 10⁷ | 8.4 × 10⁹ |
| Cotton | fabric | | | | | |

Results summarized in table 13 show that untreated cotton fabric laundered with or without washing powder demonstrated no antibacterial effect.

TABLE 14
Results obtained with Staphylococcus aureus- ATCC 6538
-100% PET fabric treated with formulation of Table 10

| | | | Bacterial count (after different | | | |
|---|---|---|---|---|---|---|
| | | | contact times) CFU/ml | | | |
| Fabric | Treatment | % MgO | 0 | 2 hr | 5 hr | 24 hr |
| 100% | Untreated | 0 | 3.2 × 10⁵ | 5.4 × 10⁵ | 6.8 × 10⁷ | 5.3 × 10⁹ |
| PET | fabric | | | | | |
| 100% | Treated fabric | 0.1 | — | 1.8 ×10⁵ | 7.4 × 10⁶ | 1.0 × 10⁹ |
| PET | laundry 1/4 | | | | | |
| 100% | Treated fabric | 0.12 | — | 1.3 × 10⁵ | 6.8 × 10⁵ | 5.2 × 10⁸ |
| PET | laundry 2/4 | | | | | |
| 100% | Treated fabric | 0.13 | — | 7.6 × 10⁴ | 5.5 × 10⁵ | 5.3 × 10⁹ |
| PET | laundry 3/4 | | | | | |
| 100% | Treated fabric | 0.2 | — | 5.1 × 10⁴ | 9.5 × 10² | 1.0 × 10⁹ |
| PET | laundry 4/4 | | | | | |

Results summarized in table 14 indicate that polyethylene (PET) fabric treated with the magnesia formulation of table 10 after a contact time of 2 hours, showed no activity after 1, 2 laundries and a decrease of 1 log after 3 and 4 laundries.

In addition, PET fabric treated with the magnesia formulation of table 10 after a contact time of 5 hours showed a biostatic effect after 1, 2 and 3 laundries and a decrease of 2 logs after 4 laundries.

### Example 12

Demonstration that Magnesia is Effective Against e-cli

In order to test whether the anti-bacterial properties of magnesia delivered to fabric via fabric softener are effective against other bacteria, an additional experiment was conducted using E. coli. Results are summarized in Table 15.

TABLE 15
Results obtained with E.coli - cotton fabric- ATCC 8739 ATCC

| | | | Bacterial count (after different | | | |
|---|---|---|---|---|---|---|
| | | | contact times) CFU/ml | | | |
| Fabric | Treatment | % MgO | 0 | 2 hr | 5 hr | 24 hr |
| 100% | Untreated | 0 | 5.5 × 10⁵ | 1.0 × 10⁶ | 1.2 × 10⁸ | 4.9 × 10⁹ |
| Cotton | blank | | | | | |
| | fabric | | | | | |
| 100% | Treated fabric- | 0.33 | — | 5.5 × 10³ | 7.0 × 10⁵ | 1.8 × 10⁷ |
| Cotton | laundry 1/4 | | | | | |
| 100% | Treated fabric | 0.5 | — | 1.2 × 10³ | 1.2 × 10⁴ | 2.1 × 10⁷ |
| Cotton | laundry 2/4 | | | | | |
| 100% | Treated fabric | 0.66 | — | 9.3 × 10² | 1.3 × 10⁴ | 1.7 × 10⁷ |
| Cotton | laundry 3/4 | | | | | |
| 100% | Treated fabric | 0.83 | — | 5.9 × 10³ | 1.0 × 10² | 2.9 × 10⁷ |
| Cotton | laundry 4/4 | | | | | |

Results summarized in Table 15 show that E. coli started to grow on untreated blank fabric after 5 hours. An increase of 3 and 4 orders were obtained after 5 and 24 hours, respectively. All the treated samples showed a decrease of at least 3 logs after a contact time of 2 hours. Treated fabric after 1 laundry showed a decrease of 3 logs after 5 hours (relative to untreated fabric).
Treated fabric after 2 or 3 laundries showed a decrease of 4 logs after 5 hours (relative to untreated fabric).
Treated fabric after 4 laundries showed a decrease of 6 logs after 5 hours (relative to untreated fabric).

### Example 13

### Additional Premix Formulations

Additional exemplary pre-mix formulations are set forth in Table 16.

TABLE 16
Additional premix formulations with 29% solids

| Sample# | % MgO | % Tersperse | % H20 | % HEC |
|---|---|---|---|---|
| A | 27 | 5.4 | 67.2 | 0.4 |
| B | 25 | 9 | 65.6 | 0.4 |
| C | 26.4 | 7 | 66.2 | 0.4 |

The most stable formulation (A) was used to prepare different formulations of the laundry softener and the composition as described below. In these experiments the HEC thickener was-CELLOSIZE™, QP-100 HEC QP 100MH, Dow.

### Example 14

### Influence of Varying Amounts of Pre-Mix Setavin CDP and MgCL₂ on Anti-Bacterial Activity

In order to test whether magnesia delivered to fabric via fabric softener would impart anti-bacterial properties to the fabric, an additional series of experiments with varying amounts SETAVIN CDP, MgCl₂, and magnesia pre-mix was conducted.

All of the formulations based on SETAVIN CDP, MgCl₂ and magnesia pre-mix had good stability and good pourability.

TABLE 17
Additional softener formulations with 29% solids

| Softener | | | | | | |
|---|---|---|---|---|---|---|
| Sample# | Softener % | MgO% | CDP% | H2O% | HEC% | MgCl_{%} |
| S-A | 54 | 19.4 | 4.3 | 21.5 | 0.2 | 0.5 |
| S-B | 53.8 | 19.3 | 4.3 | 21.5 | 0.2 | 0.9 |
| S-C | 53.4 | 19.22 | 4.3 | 21.3 | 0.2 | 1.5 |

Using the formulation of Table 18 below, antibacterial assays were conducted on fabric using regular fabric softener as a control to determine if the magnesia enhanced fabric softener imparted anti-bacterial (Staphylococcus aureus—ATCC 6538) properties to the laundered fabric. Results are summarized in table 19. Fabric was 50% cotton/50% polyester in every case. Treated fabric was laundered 4 times in succession.

TABLE 18
additional exemplary softener formulation

| Component | Amount [gr] | % |
|---|---|---|
| H₂0 | 120 | 21.5 |
| HEC | 1.2 | 0.21 |
| softener | 300 | 53.8 |
| Setavin CDP | 24 | 4.3 |
| MgO Pre-Mix | 108 | 19.3 |
| (29% solids) | | |
| MgCl₂ | 4.4 | 0.9 |

TABLE 19
Bacterial count on fabric after different contact times

| | | Bacterial count (after different | | | |
|---|---|---|---|---|---|
| | | contact times) CFU/ml | | | |
| Treatment | % MgO | 0 | 2 hr | 5 hr | 24 hr |
| Untreated | 0 | 2.1 × 10⁵ | 3.9 × 10⁵ | 2.3 × 10⁷ | 2.91 × 10⁹ |
| Treated fabric | 0.83 | | 8 × 10⁴ | 4.6 × 10⁴ | 7.2 × 10⁵ |
| laundry 1/4 | | | | | |
| Treated fabric | 1.53 | | 7.4 × 10⁴ | 2.3 × 10⁴ | 7.2 × 10⁵ |
| laundry 2/4 | | | | | |
| Treated fabric | 1.91 | | 6.4 × 10⁴ | 8.6 × 10³ | 3.2 × 10⁴ |
| laundry 3/4 | | | | | |
| Treated fabric | 2.24 | | 6.1 × 10⁴ | 9.6 × 10³ | 5.4 × 10⁵ |
| laundry 4/4 | | | | | |

These results indicate that addition of Setavin CDP which improves long term stability of the softener formulation does not detract from the good antibacterial properties of the formulation.

### Example 15

### Influence of Varying Amounts of Pre-Mix Setavin CDP and Acetic Acid on Anti-Bacterial Activity

In order to test whether magnesia delivered to fabric via fabric softener would impart anti-bacterial properties to the fabric, an additional series of experiments with varying amounts SETAVIN CDP, Acetic acid and magnesia pre-mix was conducted.

All of the formulations based on SETAVIN CDP, Acetic acid and magnesia pre-mix had good stability and good pourability.

TABLE 20
Additional Exemplary softener compositions with acetic acid

| Softener | | | | | | |
|---|---|---|---|---|---|---|
| Sample# | Softener % | MgO% | CDP% | H₂O% | HEC% | AA% |
| Acidified-A | 52.2 | 19.15 | 4.3 | 22.7 | 0.3 | 1.4 |
| Acidified-B | 54 | 19.4 | 4.3 | 21.1 | 0.3 | 1 |
| Acidified-C | 52.2 | 18.8 | 4.3 | 22.5 | 0.3 | 1.9 |

The formulation of Table 21 was used in antibacterial assays on fabric as in the previous example. The fabric in the first experiment was a 50/50 knit of cotton and PET, in the second experiment a woven fabric of 50/50 cotton and PET was employed as in the previous example. Results are summarized in Table 22 and Table 23 respectively.

TABLE 21
Additional Exemplary softener formulation with acetic acid

| Component | Amount [gr] | % |
|---|---|---|
| H₂0 | 120 | 21.5 |
| HEC | 1.2 | 0.21 |
| softener | 300 | 53.7 |
| Setavin CDP | 24 | 4.3 |
| MgO Pre-Mix | 108 | 19.3 |
| (29% solids) | | |
| Acetic Acid 50% | 5.65 | 1.0 |

TABLE 22
Bacterial count on knit fabric laundered with acidified
magnesia softener after different contact times

| | | Bacterial count (after different | | | |
|---|---|---|---|---|---|
| | | contact times) CFU/ml | | | |
| Treatment | % MgO | 0 | 2 hr | 5 hr | 24 hr |
| Untreated | 0 | 1.4 × 10⁵ | 5.0 × 10⁵ | 2.0 × 10⁷ | 2.1 × 10⁹ |
| Treated fabric | 0.83 | | 3.8 × 10⁴ | 1.64 × 10⁴ | 8.9 × 10³ |
| laundry 1/4 | | | | | |
| Treated fabric | 1.53 | | 2.9 × 10⁴ | 1.6 × 10⁴ | 6.0 × 10³ |
| laundry 2/4 | | | | | |
| Treated fabric | 1.91 | | 4.0 × 10⁴ | 1.6 × 10⁴ | 7.5 × 10¹ |
| laundry 3/4 | | | | | |
| Treated fabric | 2.24 | | 2.4 × 10⁴ | 2.4 × 10³ | 2.0 × 10⁴ |
| laundry 4/4 | | | | | |

TABLE 23
Bacterial count on woven fabric laundered with acidified
magnesia softener after different contact times

| | | Bacterial count (after different | | | |
|---|---|---|---|---|---|
| | | contact times) CFU/ml | | | |
| Treatment | % MgO | 0 | 2 hr | 5 hr | 24 hr |
| Untreated | 0 | 2.9 × 10⁵ | 3.2 × 10⁵ | 2.5 × 10⁷ | 1.89 × 10⁹ |
| Treated fabric | 0.83 | | 5.6 × 10⁴ | 4.7 × 10³ | 2.4 × 10⁵ |
| laundry 1/4 | | | | | |
| Treated fabric | 1.53 | | 4.7 × 10⁴ | 6.9 × 10³ | 6.6 × 10⁴ |
| laundry 2/4 | | | | | |
| Treated fabric | 1.91 | | 3.4 × 10⁴ | 1.5 × 10³ | 2.3 × 10⁵ |
| laundry 3/4 | | | | | |
| Treated fabric | 2.24 | | 2.3 × 10⁴ | 3.2 × 10³ | 4.8 × 10⁵ |
| laundry 4/4 | | | | | |

These results indicate that acidification the of Setavin CDP containing formulations as in Example 14 (which improves long term stability of the softener formulation) does not impair the good antibacterial properties of the formulation.

1. A composition comprising:
(a) conventional fabric softener components;
(b) magnesia (MgO); and
(c) at least one member of the group consisting of cationic polyacrylo-nitrile and alkylamine ethoxylate.

2. (canceled)

3. The composition according to claim 1, wherein said at least one cationic polyacrylo-nitrile comprises a quaternary ammonium derivate.

4. The composition according to claim 1, comprising Hydroxyethyl Cellulose.

5. The composition according to claim 1, comprising a dispersant.

6. A method of manufacture comprising:
(a) preparing a pre-mix of magnesia (MgO) in water with a dispersant; and
(b) adding a cationic polyacrylo-nitrile and an alkylamine ethoxylate and said pre-mix to a fabric softener to produce a magnesia enhanced fabric softener.

7. The method according to claim 6, wherein said preparing includes:
stirring liquid dispersant into water; and
gradually adding magnesia powder with stirring; and then
adding a thickener while stirring.

8. Magnesia (MgO) for use as a fabric treatment in conjunction with fabric softener.
